(19) United States
(12) Patent Application Publication
(10) Pub. No.: US 2021/0216619 A1
(43) Pub. Date: Jul. 15, 2021

(54) METHOD AND APPARATUS FOR AUTHENTICATING A USER OF A COMPARTMENT INSTALLATION

(71) Applicants: Frank Helferich, Leubsdorf (DE); Thomas Baye, Bonn (DE); Christoph Dautz, Bonn (DE); Philipp Oberländer, Bonn (DE); Frank Reichwald, Troisdorf (DE)

(72) Inventors: Frank Helferich, Leubsdorf (DE); Thomas Baye, Bonn (DE); Christoph Dautz, Bonn (DE); Philipp Oberländer, Bonn (DE); Frank Reichwald, Troisdorf (DE)

(73) Assignee: Deutsche Post AG, Bonn (DE)

(21) Appl. No.: 17/130,303

(22) Filed: Dec. 22, 2020

(30) Foreign Application Priority Data
Jan. 13, 2020 (DE) 102020100543.1

(51) Int. Cl. G06F 21/34; H04L 9/32; H04L 9/08; H04L 29/06; G06Q 10/08

(52) U.S. Cl. CPC G06F 21/34; H04L 9/3247; G06F 2221/2111; H04L 63/0435; G06Q 10/0836; H04L 9/0825

(57) ABSTRACT

A method comprising performing a process for authenticating a user of a compartment installation vis-à-vis a backend system managing the compartment installation. A necessary condition for performing the process for authenticating the user is that a proximity check has revealed that a mobile device of the user is situated at the location of the compartment installation, and/or that an occupancy check has revealed that the compartment installation contains at least one shipment assigned to the user. A corresponding apparatus, a corresponding system and a corresponding computer program are furthermore disclosed.

### CROSS-REFERENCE TO THE RELATED PATENT APPLICATIONS

This patent application claims the benefit of German Patent Application No. 10 2020 100 543.1 filed on Jan. 13, 2020, the entire teachings and disclosure of which are incorporated herein by reference thereto.

### FIELD

Exemplary embodiments of the invention relate to a method, an apparatus, a system and a computer program for authenticating a user of a compartment installation, in particular a compartment installation for delivery or carrier services to collect and/or put in shipments.

### BACKGROUND

Compartment installations are used diversely in the form of lockbox or parcel compartment installations, for example. One example of a parcel compartment installation is the applicant's package station, to which a recipient may have shipments delivered. The deliverer places the shipment into a compartment of a package station situated in proximity to the recipient and/or previously defined by the recipient, the compartment is locked and the recipient is notified accordingly. In order that the notified recipient may remove a shipment provided for him/her from a compartment of the compartment installation, the recipient, before opening the compartment or compartments, must authenticate himself/herself or verify his/her access authorization by means of providing one or more correct pieces of access authorization information.

In one realization of the applicant's package station mentioned above, the recipient, when verifying the authorization for access to one compartment or a plurality of compartments, must input a user identifier, also called post number, permanently assigned to the recipient functionally as a customer number and, in addition, a temporarily valid collection code into an input apparatus, for example a numeric keypad, of the package station. The temporarily valid collection code, known as mTAN (mobile transaction number) from the applicant's realization mentioned, has previously been communicated electronically to the user together with the notification that one or more shipments are ready for the user to collect in the designated package station. The respective pieces of access authorization information of users registered to use the package station, that is to say the user identifiers and the collection codes or post numbers and mTANs, are managed and stored by a backend system. The package stations functioning as compartment installations are coupled to the backend system via long-range data communication connections, for example via LAN (Local Area Network) interfaces, for exchanging data required for the access authorization check.

As protection against attacks with the aim of obtaining unauthorized access to the package station compartments and possible theft of the shipments contained therein, in the case where an invalid collection code is input three times, the user or the user identifier thereof is completely excluded from future use of the package station by blocking of the user or the user identifier thereof being registered and stored in the backend system. For unblocking his/her user identifier, the blocked user has to call on a package station administrator.

### SUMMARY OF SOME EXEMPLARY EMBODIMENTS OF THE INVENTION

In order that a user of a compartment installation is granted access to one or more compartments of the compartment installation, the user must previously verify his/her identity and/or access authorization by means of providing (pieces of) access request information, such as the post number and mTAN mentioned above, for example, during an authentication. Afterward, an authentication apparatus, by performing a process for authenticating the user, checks whether or not the identity and/or access authorization asserted by the user are/is valid. It is only if the validity of the asserted identity and/or access authorization has been ascertained by the check in the process for authenticating the user that the user is positively authenticated or authorized for access to one or more compartments of the compartment installation. In the process for authenticating the user, the authentication apparatus checks the validity of the (pieces of) access request information provided for authentication by means of referencing stored pieces of access authorization information. The user is positively authenticated and authorized for access by the authentication apparatus only under the condition that the authentication apparatus has verified and confirmed the validity of the (pieces of) access request information provided during the authentication. By way of example, the authentication apparatus positively authenticates the user only if the access request information provided by the user corresponds to access authorization information stored for this user or can be mapped thereto by means of a predetermined transformation.

The pieces of access authorization information of the users of one or more compartment installations of this type, said information being referenced for the authentication, are stored and managed by a backend system. The backend system is formed by one or more server apparatuses that manage the pieces of access authorization information of registered users for performing a process for authenticating a user and store said information ready for retrieval.

The present application is directed to methods for authenticating a user of a compartment installation and to apparatuses configured to perform such methods in which the user provides pieces of access request information during authentication and authentication of the user is subsequently attempted on the basis of pieces of access authorization information stored in the backend system. It is only if the access request information provided matches the stored access authorization information that the user is successfully or positively authenticated and authorized as a legitimate user for access to one or more compartments of the compartment installation.

In order to be authorized for access to one compartment or a plurality of compartments of a compartment installation managed by the backend system, the user has to be positively authenticated by involvement and participation of the backend system. The check or verification that the user being authenticated is a user who is actually authorized for access to one compartment or a plurality of compartments of a compartment installation managed by the backend system is effected using pieces of access authorization information stored in the backend system, preferably with access to the pieces of access authorization information stored in the backend system during the process for authenticating the user.

In order to ensure secure and stable operation of the backend system and thus also of the compartment installation(s) managed by the backend system, the backend system must be protected against malicious attackers. Firstly, the pieces of access authorization information stored in the backend system must be protected against unauthorized access. Attackers must be prevented from determining valid pieces of access request information for example by testing as frequently as desired a plurality of passwords and codes by means of a so-called brute force attack, and from obtaining access to the compartments of the compartment installation by way of authentication on the basis of the impermissibly obtained pieces of access request information. Moreover, the backend system must be protected against so-called denial of service attacks, in which attackers use a flood of permanently effected authentication enquiries to shut down the operation of the backend system managing the compartment installations and thus also the operation of all managed compartment installations.

In the case of the applicant's package station concept presented in the introduction, a user of a package station firstly has to input access information in the form of the six- to twelve-digit post number, which is permanently assigned to the user and therefore hardly secret, and a collection code, which is only temporarily valid, is formed by a few digits and was communicated electronically to the user upon one or more shipments intended for the user having been placed into the package station, into an input terminal of the package station, for example a numeric keypad. Since the post numbers at the very most have limited secrecy or are even known and are taken from a limited range of values, and the collection codes originate from a very limited range of values, very stringent protection measures are needed to prevent unauthorized access to the compartments of the compartment installation by testing code combinations. The complete blocking of a user or the user identifier thereof in reaction to an invalid collection code being input three times is sufficient as such a protection measure against attackers, but is very inconvenient and annoying for a user who is inherently trustworthy and reliable and is blocked on account of brief inattentiveness when inputting the code. From the standpoint of a package station operator, the unnecessarily strict treatment of the merely inattentive user as outlined entails the disadvantage that the compartments of the compartment installation that are assigned to the user at the time of blocking are blocked at least until the user or the user identifier thereof is unblocked, or it even becomes necessary for compartments to be emptied by the package station operator.

In the case of the applicant's package station concept presented in the introduction, denial of service attacks are effectively prevented by virtue of the fact that the pieces of access request information, that is to say the post number and the mTAN, have to be manually input into an input apparatus of the package station by the user, such that continuous and remotely controlled initiation of a flood of authentication processes is not possible.

The applicant's package station system presented in the introduction and the mechanisms configured therefor for authenticating and authorizing registered package station users have attained very great acceptance among users in recent years. However, the technical complexity and the required costs for realizing the applicant's package station system presented above are high. Every package station or compartment installation contains or is assigned a respective powerful computer having a high power consumption. Moreover, each of these computers has to be connected to the backend system via a wired and/or wireless data communication connection, for example via the internet, in order to exchange data for authenticating and authorizing users and for managing the compartments. From the applicant's standpoint, it is desirable to reduce the operating and manufacturing costs of existing compartment installations and compartment installations to be set up in the future, without the users having to be confronted with a change or adjustment in the hitherto customary method for verifying their access authorization. Moreover, the hitherto customary high level of protection against attacks on the compartment installations and the backend system ought to be maintained.

The problem addressed by the present invention is that of overcoming one or more of the disadvantages described above and/or achieving one or more of the sought improvements described above.

The disclosure presents an exemplary embodiment of a method according to the invention and also of an associated apparatus, of an associated system and of an associated computer program.

An exemplary embodiment of a method according to the invention comprises performing a process for authenticating a user of a compartment installation vis-à-vis a backend system managing the compartment installation. A necessary condition for performing the process for authenticating the user is that a proximity check has revealed that a mobile device of the user is situated at the location of the compartment installation. An alternative or optional further necessary condition for performing the process for authenticating the user is that an occupancy check has revealed that the compartment installation contains at least one shipment assigned to the user. The exemplary embodiment of the method according to the invention is partially or completely performed for example by at least one apparatus of the backend system that is configured as an authentication apparatus.

Further exemplary properties of the exemplary embodiment of the method according to the invention are presented below, which should be deemed to be disclosed equally for the associated apparatus, the associated system and the associated computer program and, in particular, should also be deemed to be disclosed in all technically expedient combinations with one another.

The compartment installation comprises a plurality of compartments (that is to say more than one compartment or more two compartments, for example). The compartments are configured to receive shipments (e.g. letters, parcels, packages), deliveries (e.g. washed laundry or laundry to be washed, meals from delivery services (e.g. a pizza or sushi service), etc.) or items (e.g. valuables, luggage, etc.), for example. The compartments are each sealable, for example by means of a respective door or shutter. By way of example, the compartments are substantially parallelepipedal receiving containers provided with doors or shutters on one or more sides. By way of example, multiple compartments in the compartment installation are arranged one above another and/or next to one another. By way of example, the compartment installation may consist of one or more modules arranged next to one another, with one or more compartments in each module being arranged one above another. The respective doors of the compartments are then fixed on laterally, for example, and may be opened forward, for example. The compartments of the compartment installation may all have the same size. Alternatively, at least some compartments of the compartment installation may have different sizes. The compartment installation may have compartments for letters (letter compartments) and/or compartments for parcels (parcel compartments), for example. The letter compartments each have the same size within the compartment installation, for example, but two or more different sizes are also possible. The parcel compartments may be represented by just one identical size or by different sizes in the compartment installation. The compartment installation may be configured as a parcel compartment installation or a combined letter and parcel compartment installation, for example.

Each of the compartments is provided with a respective lock, for example, in order to be able to control access to the individual compartments of the compartment installation by users. By way of example, the lock of a compartment may be arranged in or on the compartment, for example on a door (e.g. also in the form of a shutter) of the compartment. If the lock is not arranged on the door (that is to say is arranged on a lateral wall of the compartment, for example), then it interacts with the door, for example, by virtue of a bolt being introduced into an opening in the door and pulled out again, for example. The lock of a compartment may return to a locked position as standard, for example, and then be actuable only for unlocking purposes, for example. After the lock has been unlocked, it is then possible for the door of the compartment to be opened, for example. Since the lock automatically returns to the locked position, locking of the compartment may be achieved by closing the door, for example by virtue of a catch function of the lock being utilized when closing the door.

The process for authenticating the user of a compartment installation comprises obtaining or receiving one or more pieces of access request information of the user and authenticating the user on the basis of at least the one or more pieces of access request information obtained or received. The pieces of access request information of the user are obtained from the mobile device of the user and/or from a data interface of a compartment installation, said data interface being connected to the backend system, by at least one apparatus of the backend system that is configured as an authentication apparatus, for example.

The pieces of access request information are provided by the user during authentication. The pieces of access request information are provided by the user inputting data into a mobile device assigned to the user and/or into an input apparatus assigned to a compartment installation. Alternatively or optionally, by means of an interaction with the mobile device and/or the input apparatus of the compartment installation, the user may cause the pieces of access request information to be communicated to the backend system in order to provide the pieces of access request information to the process for authenticating the user.

The mobile device of the user preferably performs the function of a user interface for the compartment installation, such that the compartment installation may be configured in a particularly simple manner. The operational control of the compartment installation is then effected by the mobile device, for example, in particular by an app installed thereon, which, for the purpose of authenticating the user, communicates with the backend system and/or in the form of a relay enables data to be exchanged between the backend system and the compartment installation. To that end, the compartment installation communicates with the mobile device via a close-range data communication connection (e.g. Bluetooth, NFC, RFID, WLAN, ZigBee, etc.) and they need not be able to set up in particular a remote data communication connection (e.g. a cellular mobile radio connection) to the backend system since this functionality is provided by the mobile device.

The pieces of access request information which are provided by the user and are obtained during the authenticating process are for example a user identifier (or some other identifier), such as the post number mentioned above, and/or a code (e.g. in the form of a collection code) or password, such as the mTAN mentioned above. Alternatively or optionally, at least one portion of the pieces of access request information—for example instead of the user identifier—is provided by means of referencing token information stored on the mobile device, said token information having been stored on the mobile device on the occasion of a previous positive authentication of the user. Alternatively or optionally, the pieces of access request information contain a shipment reference, which is electronically generated individually by the compartment installation or the backend system for example in the event of respective transport commissioning or when a shipment is placed into a compartment of a compartment installation. The pieces of access request information provided by the user can be partially or completely assigned to the user permanently or at least for a period of time extending beyond successful authentication of the user. Alternatively or optionally, the pieces of access request information provided by the user are valid only for a single successful authentication or a single access to one compartment or a plurality of compartments of the compartment installation visited by the user, such that after a successful authentication of the user, provision of the same pieces of access request information by the user does not result in a renewed successful authentication of the user.

The process for authenticating the user of a compartment installation involves checking whether or not the identity and/or access authorization asserted by the user by means of providing pieces of access request information are/is valid. The user has provided the pieces of access request information previously during his/her authentication, for example by inputting his/her user identifier and a collection code communicated electronically to the user previously on the occasion of a shipment having (in particular just) been deposited. It is only if the validity of the asserted identity and/or access authorization has been ascertained by the check during the process for authenticating the user that the user is positively authenticated or authorized for access to one or more compartments of the compartment installation. In the process for authenticating the user, the validity of the (pieces of) access request information provided for authentication is checked by means of referencing stored pieces of access authorization information. The user is positively authenticated and authorized for access only under the condition that the validity of the (pieces of) access request information provided during authentication has been verified and confirmed. By way of example, the user is positively or successfully authenticated only if the access request information provided by the user corresponds to access authorization information stored for this user or may be mapped thereto by means of a predetermined transformation. Otherwise, if the pieces of access request information provided by the user have been evaluated as invalid during the check, the authentication is ended without success or with a negative result. The result of the fully performed process for authenticating the user is such that the user is either authenticated—in the case of authentication with a positive result—or not authenticated—in the case without authentication of the user or with a negative result.

A number of performed processes for authenticating the user without the user having been authenticated, that is to say with a negative result, which number exceeds a defined threshold value, has the consequence in subsequently performed processes for authenticating the user, for example, that the user may no longer be authenticated permanently, at least for a predefined time period, for example at least 1 hour, preferably 24 hours, or until a predetermined event occurs, such as a release of the blocked user in the backend system, for example. The threshold value may be defined in a user-specific way and/or in a compartment-installation-specific way. The threshold value is defined in a user-specific way for example such that a user acquires a blocking entry in the backend system after a total 3 unsuccessful authentications. Once such a blocking entry has been set for the user in the backend system, the user is denied a renewed attempt to authentication, for example, the process for authenticating the user not being started or being terminated prematurely without authentication. The threshold value is defined in a compartment-installation-specific way for example such that a process for authenticating a user is not performed or started for a predefined time period, for example at least 1 hour, if previously a defined number of authentications initiated by one or more users at the location of the compartment installation have been performed without authentication of a user.

In the process for authenticating a user of a compartment installation vis-à-vis a backend system managing the compartment installation, the user is authenticated vis-à-vis the backend system. In this case, the authentication of the user vis-à-vis the backend system denotes the fact that the check of whether the pieces of access request information provided by the user seeking authentication are valid is performed on the basis of pieces of access authorization information that are stored and managed by the backend system. The validity of the pieces of access request information provided for authentication is checked for example by the backend system with the consultation of the pieces of access authorization information stored and managed in the backend system. Within the meaning of the invention, however, the authentication of the user vis-à-vis the backend system also denotes a check of the pieces of access request information on the basis of a copy or reproduction of the pieces of access authorization information stored in the backend system. Moreover, the authentication of the user vis-à-vis the backend system denotes the fact that the backend system at least participates in the respective performance of the authentication, and that the final result of the process for authenticating the user—either with a positive authentication of the user or without authentication of the user—is determined solely by the backend system.

In the method of the invention, the fact of whether or not the process for authenticating the user is actually performed depends on the result of a proximity check and/or the result of an occupancy check.

The result of the proximity check indicates whether or not the mobile device of the user is situated at the location (in particular at the current location) of the compartment installation (installed for example in a stationary fashion). The result of the proximity check thus specifies that the mobile device of the user either is situated spatially close enough to the current location of the compartment installation or is too far away from this location of the compartment installation. The proximity check reveals that the mobile device is situated at the location of the compartment installation if the mobile device or the app implemented thereon detects the compartment installation visited by the user and/or the compartment installation detects the mobile device. The detection of the proximity of mobile device and compartment installation that is used for the proximity check may be based on a wireless and/or wired connection between the mobile device and the compartment installation, the arising of this connection being a necessary criterion of the presence of the proximity. The detection may require for example the arising of a near field coupling, for example an inductive or capacitive coupling, between the mobile device and the compartment installation as a necessary criterion for the presence of the proximity, or the arising of a radio connection between the mobile device and the compartment installation, for example with at least a predefined signal-to-noise ratio or a predefined signal-to-noise-and-interference ratio.

In the exemplary embodiment of the method according to the invention, the detection of the proximity of the mobile device of the user and the compartment installation for the proximity check may be effected using an interface of the mobile device for a close-range data communication connection, such as Bluetooth, NFC (Near Field Communication), WLAN (Wireless Local Area Network) or ZigBee, for example, to name just a few examples. For performing this detection, the compartment installation is likewise provided with an interface for a close-range data communication connection, such that a close-range data communication connection is establishable between these interfaces of the mobile device and the compartment installation. It is only under the condition that the close-range data communication connection between the compartment installation and the mobile device is establishable or has been established that the presence of a sufficient proximity between mobile device and compartment installation is detected, and the proximity check reveals that the mobile device is situated at the location of the compartment installation. The maximum permissible distance sought between the mobile device and the compartment installation in order that the presence of a sufficient proximity between mobile device and compartment installation is detected is, for example, in the range of less than 100 meters, in particular of less than 10 meters.

Alternatively or optionally, as detection for the proximity check provision may be made, for example, for the mobile device to detect the compartment installation optically, for example by a screen image displayed on a screen of the compartment installation or an image applied on the compartment installation being captured and processed by means of the app implemented on the mobile device and a camera of the mobile device. Alternatively or optionally, as detection for the proximity check provision may be made for example for the compartment installation to detect the mobile device optically, for example by the compartment installation, by way of a camera or a laser scanner, capturing and processing a screen image displayed on the mobile device by the app or an image sequence or an image applied on the mobile device. The screen image or the image may be for example a bar code, in particular a QR code.

In the exemplary embodiment of the method according to the invention, under the condition that the backend system may decrypt or has decrypted a message encrypted by the compartment installation and/or that the backend system has ascertained the integrity and authenticity of a message provided with a signature by the compartment installation, the proximity check may yield the result that the mobile device is situated at the location of the compartment installation. For the check of the proximity of mobile device and compartment installation, the mobile device is used to transmit the message that has been encrypted (and/or provided with a signature) from the compartment installation to the backend system. The message that has been encrypted (and/or provided with a signature) by the compartment installation is firstly transmitted to the mobile device situated at the location of the compartment installation, for example, said mobile device being connected to the compartment installation via a close-range data communication connection, and is subsequently transmitted from the mobile device to the backend system, which is connected to the mobile device for example via a remote data communication connection of a cellular mobile radio network (that is to say, for example, GSM, E-GSM, UMTS, LTE or 5G). The encryption may be based on a symmetric or asymmetric encryption, for example, wherein for example a public key of an asymmetric key pair is present at the compartment installation and the associated private key is known to the backend system. The signature may be generated for example by cryptographic operations being performed on the message using a key (for example as an encrypted hash value over the message, or as a cryptographic hash value (e.g. as HMAC or CMAC) over the message), wherein said key is present both in the compartment installation and in the backend system and, consequently, at the backend system the signature can be calculated anew and compared with the signature generated by the compartment installation. If both signatures correspond, the integrity and authenticity of the message are then assumed.

In the exemplary embodiment of the method according to the invention, the result of the proximity check may be determined not solely by means of a position determination performable independently by the mobile device. This means that the result of the proximity check is determined differently than by a mere determination of the current geoposition, such as geographical coordinates, for example, of the mobile device and a comparison of the geoposition determined with the known geoposition of the compartment installation frequented by the user. It is preferred for the result of the proximity check to be independent of a position determination performable independently by the mobile device. Preferably, the result of the proximity check is determined without using a geoposition determining device integrated in the mobile device.

In some embodiments of the invention, the fact of whether or not the process for authenticating the user is performed depends on the result of an occupancy check.

The result of the occupancy check indicates whether or not the compartment installation visited by the user contains at least one shipment which is assigned to the user and which is provided in one or more compartments of the compartment installation for the user. In the exemplary embodiments of the invention taking into account the result of the occupancy check, the process for authenticating the user is performed only under the necessary condition that a shipment assigned to the user is actually provided in at least one of the compartments of the compartment installation. The check by the backend system as to whether pieces of access request information provided by the user are valid is omitted if the occupancy check has revealed that the compartment installation does not contain any shipment assigned to the user seeking the authentication.

In some embodiments, the current occupancy of the compartments including the current user/compartment assignment for one compartment installation or a plurality of compartment installations is managed and stored exclusively centrally by the backend system. In other embodiments, the current occupancy of the compartments including the current user/compartment assignment is managed and stored centrally in the backend system and at the same time—under the control of the backend system—locally by the respective compartment installation itself.

In the case of the compartment installations considered in the context of this application, a respective performance of an authentication of a user of a compartment installation, that is to say the check of whether or not the access request information provided by the user is correct and valid and whether—in the case of a successful authentication or in the case of a positive authentication result—the user is granted access to one or more compartments of a compartment installation, is always effected in such a way that the backend system at least participates in the respective performance of the authentication and determines the final result of the authentication either as positive or as negative.

In the exemplary embodiment of the method according to the invention, the result of the proximity check and the result of the occupancy check may be taken into account in a cascaded manner as the necessary conditions that have to be met in order that the process for authenticating the user is performed. This corresponds to a cascaded implementation of the proximity check and the occupancy check. It is only under the condition that the result of the check taken into account or performed first is positive that the other check is performed or the result of the other check is taken into account. If the check taken into account or performed first is negative, the subsequently pending check is omitted. By way of example, the occupancy check is performed or its result is taken into account only if previously the proximity check has revealed that the mobile device of the user is situated at the location of the compartment installation. In the case of central storage and management of the current occupancy of the compartments with the current recipient/compartment assignment by the backend system, the advantage is afforded that access to data stored in the backend system is required only in the case of a positive proximity check, that is to say if the mobile device is situated at the location of the compartment installation. Conversely, if the occupancy check is the check performed first, the advantage is afforded that the close-range data communication connection between the mobile device and the compartment installation need only be established in the case of a positive result of the occupancy check taken into account first A cost-effective realization of the interface of the compartment installation for the close-range data communication connection is made possible as a result. Moreover, attackers are prevented from being able to block a respective compartment installation by means of permanent enquiries.

In the exemplary embodiment of the method according to the invention, the result of the occupancy check may be defined by the backend system on the basis of one or more pieces of access request information provided by the mobile device. By way of example, the backend system receives from the mobile device a user identifier of the user seeking the authentication or token information assigned to the user (and optionally identifying the mobile device), said token information being generated in the event of a last performed successful authentication of the user (for example by the backend system) and since then being stored on the mobile device, via a long-range data communication connection, for example a cellular mobile radio network, and then checks whether a shipment has been provided for this user in a compartment installation. This occupancy check may be effected for example only specifically for a compartment installation which the user has selected by means of an app on his/her mobile device, and/or for which the proximity check has revealed that the mobile device is situated at the location of this compartment installation. In this exemplary embodiment, the check of whether the process for authenticating the user ought to be performed preferably does not necessitate data exchange between the compartment installation and the backend system.

In the exemplary embodiment of the method according to the invention, a data communication connection between the backend system and the compartment installation may be operated by means of relaying through the mobile device; in other words, the mobile device then functions as a relay. Preferably, without relaying through the mobile device, there is no direct data communication connection between the backend system and the compartment installation, and so a unidirectional or bidirectional data exchange between the backend system and the compartment installation is not possible without the mobile device coupled to the backend system and the compartment installation in each case for data exchange. The mobile device receives data from the compartment installation and transmits data to the compartment installation via a close-range data communication connection established between the mobile device and the compartment installation, such as Bluetooth, NFC, RFID, WLAN or ZigBee, for example. Moreover, the mobile device receives data from the backend system and transmits data to the backend system via a long-range data communication connection of a cellular mobile radio network (that is to say GSM, E-GSM, UMTS, LTE or 5G, for example) established between the mobile device and the backend system. The relaying of the data from the backend system to the compartment installation and in the opposite direction, this relaying being effected through the mobile device, is controlled for example by software executed or running on the mobile device, in particular in the form of an app. The establishment of the close-range data communication connection between the compartment installation and the mobile device and the establishment of the long-range data communication connection between the mobile device and the backend system are for example likewise initiated and controlled by the software executed on the mobile device.

In the exemplary embodiment of the method according to the invention, the above-described data communication connection between the backend system and the compartment installation may be established and operated only under the condition that the occupancy check has revealed that the mobile device is situated at the location of the compartment installation, and/or that the occupancy check has revealed that the compartment installation contains at least one shipment assigned to the user.

In this case, the interface—used for the proximity check—between mobile device and compartment installation for a close-range data communication connection may be the same interface as the interface for the close-range data communication connection that is used when the mobile device is used as a relaying unit (in particular as a relay) between the backend system and the compartment installation (which allows in particular a more cost-effective and more compact implementation of the mobile device), or may differ from this interface (which allows more degrees of freedom in the trade-off between security (shortest possible range) and data transmission capacity (as high as possible)). By way of example, the proximity check may be based on NFC (short range and thus high security in the proximity check), while the relaying is based on WLAN (high data transmission capacity).

It is preferred, moreover, for the data communication connection between the backend system and the compartment installation to be established and operated only under the necessary condition that the user has been successfully authenticated by the backend system on the basis of pieces of access request information provided by the user. It is only in the case of a successful authentication of the user that the backend system—via the data communication connection established on the occasion of the authorization of the user, preferably with relaying through the mobile device—authorizes the compartment installation by means of suitable control commands for unlocking or opening at least one of the compartments of this compartment installation that are assigned to the user.

In the exemplary embodiment of the method according to the invention, an additional or alternative necessary condition with regard to the proximity check and/or the occupancy check for performing the process for authenticating the user may be that an authentication enquiry that is intended to initiate the process for authenticating the user has not been classified as suspicious on the basis of a counter. The counter detects for example how often within a predefined time interval or time interval adapted dynamically according to a predefined rule an authentication enquiry that is intended to initiate the process for authenticating the user (for example by at least partly providing the access request information, for example the user identifier) has been made, for example to the backend system. If the counter exceeds a predefined threshold value or threshold value adapted dynamically according to a predefined rule, a decision is taken, for example, that the authentication enquiry should be classified as suspicious since it has taken place too frequently within the time interval. This has the consequence that the process for authenticating the user is not performed. The counter may be specific only to a respective user (that is to say independent of the respective compartment installation), or may be specific to a combination of a respective user and a respective compartment installation, or may only be specific to a compartment installation (that is to say user-independent).

In the exemplary embodiment of the method according to the invention, the method may furthermore comprise generating a temporary session key, encrypting the temporary session key generated, and transmitting the encrypted session key to the backend system. The temporary session key is generated and encrypted by the compartment installation, for example. The temporary session key is generated by the compartment installation for example at the point in time or upon the event when a close-range data communication connection, for example by way of Bluetooth, NFC, RFID, WLAN or ZigBee, is established between the compartment installation and the mobile device of the user, as during the proximity check, for example. The temporary session key is generated as a random value, for example. The temporary session key is provided as a key value for data communication between the backend system and the compartment installation with relaying through the mobile device and with end-to-end encryption between the backend system and the compartment installation. The session key is temporarily valid, and the validity ends after a predetermined time duration has elapsed, for example upon a maximum time period being exceeded without data exchange between the compartment installation and the backend system, such as 2 minutes, for example, or after the completion of the process for authenticating the user, to name just a few examples. The temporary session key is preferably encrypted by means asymmetric cryptographic encryption in such a way that a so-called public key of the backend system, this key being known to the compartment installation, is used for encrypting the temporary session key. The encrypted temporary session key is decryptable with the aid of a so-called private key of the backend system. The encrypted session key is preferably transmitted from the compartment installation to the mobile device via a close-range data communication connection and then from the mobile device to the backend system via a long-range data communication connection, for example via a cellular mobile radio network.

The term public key of the backend system, this key being known to the compartment installation, is understood to mean that this public key is known to at least one of the compartment installations managed by the backend system. However, the public key is permitted to be known only to the compartment installations themselves, since otherwise an attacker having knowledge of this public key may pretend to be a compartment installation. The private key of the backend system is stored in an apparatus of the backend system with stringent protection measures against access by unauthorized entities. The public key of the backend system is used for encrypting messages that are decryptable only using the private key of the backend system. In accordance with the concept of asymmetric encryption, the private key is defined such that it may not be calculated at all from the public key or may be calculated from the public key only with extremely high time expenditure and calculation complexity.

In order to make it more difficult for attackers to gain access to the public key of the backend system, the public key of the backend system is not generally known or published, but rather is integrated into the firmware of the compartment installation, for example. For every firmware update, for example, a new asymmetric key pair is generated, with integration of the public key of the backend system into the firmware, as a result of which regular replacement of the private key in the backend system and of the public key in all compartment installations managed by the backend system is compelled, and security against attacks with older keys that have possibly become known is thus increased. If an external development service provider participates in development of the firmware, then this service provider preferably only acquires test version keys that are ineffective during everyday operation of the compartment installations and of the backend system, that is to say outside a limited testing environment After the firmware created has been handed over to the operator of the backend system by the development service provider, the operator replaces the test version keys by effective or productive keys. Furthermore, security can be increased by means of a challenge-response concept, which provides for the backend system to send a challenge message with an integrated, possibly encrypted, time stamp to the compartment installation, and for the compartment installation to send the time stamp back to the backend system as a response message. Key management may also be provided in such a way that each compartment installation employs an individual asymmetric encryption (which is likewise changed with every firmware update, for example). By way of example, the RSA method with a 2048-bit key value may be used for the asymmetric encryption.

In the exemplary embodiment of the method according to the invention, the method may additionally comprise receiving an encrypted session key from the compartment installation, decrypting the encrypted session key, and end-to-end encrypting—using the decrypted session key—of data communication between the backend system and the compartment installation. The encrypted session key is preferably a key value encrypted by means of asymmetric encryption. The encrypted session key is for example a session key that has been encrypted by the compartment installation using a public key of the backend system and has subsequently been transmitted to the backend system, as already explained in the section above. The encrypted session key received is then decrypted by the backend system using the private key of the backend system to form a decrypted session key. The decrypted session key is used to effect end-to-end encryption of data of data communication between the backend system and the compartment installation (which serves for example for transmitting control and/or status information, for example commands for opening one or more determined compartments of the compartment installation). For this end-to-end encryption of the unidirectional or bidirectional data communication between the backend system and the compartment installation, symmetric encryption is preferably used, in which the backend system and the compartment installation encrypt and decrypt the messages using the decrypted session key. By way of example, AES (Advanced Encryption Standard) with a key length of 256 bits is used as a method for symmetric encryption. The session key is temporarily valid, and the validity ends after a predetermined time duration has elapsed, for example in the event of a maximum time period being exceeded without data exchange between the backend system and the compartment installation, such as 2 minutes, for example, or after the conclusion of the process for authenticating the user, to name just a few examples. The data communication with end-to-end encryption between the backend system and the compartment installation is preferably effected with relaying via the mobile device, which, under the control of an app implemented on the mobile device, receives data from the backend system and transmits this data to the compartment installation and/or receives data from the compartment installation and transmits them to the backend system. The end-to-end encryption between the backend system and the compartment installation and the mere relaying of the encrypted messages via the mobile device ensure the integrity, confidentiality and liability of the messages exchanged between the backend system and the compartment installation even if an attacker has manipulated the close-range data communication connection between the compartment installation and the mobile device, the app implemented on the mobile device, the mobile device and/or the long-range data communication connection between the mobile device and the backend system. The temporally limited validity of the session key used for encryption and decryption ensures that messages recorded by an attacker and sent repeatedly at a later point in time become invalid with no effect.

In the exemplary embodiment of the method according to the invention, the method may comprise generating token information assigned to the user and outputting the generated token information to the mobile device for storage for a future process for authenticating the user. These steps are performed by the backend system, for example. The token information is cryptographic information, the data of which are generated upon a successful authentication of a user. The token information contains at least one portion, for example not all, of the pieces of access request information (in particular no collection code or no mTAN) that a user has to provide for authentication vis-à-vis the backend system, and is generated for example in such a way that it is assigned to the authenticated user. As token information identifying the authenticated user, the token information contains as part of the access request information for example the user identifier of the user, such as the post number of the applicant's package station concept explained in the introduction, for example. Moreover, the token information contains security data coupled for example to the mobile device storing the token information, to the time of installation and/or the version of the app implemented on the mobile device, and/or to the time of generation of the token information. The token information contains as security data, for example, information for identifying the mobile device, for example a serial number of the mobile device, and/or the IMEI (International Mobile Station Equipment Identity) of a smartphone. The token information is generated, for example by the backend system, only under the necessary condition that the process for authenticating the user has been concluded successfully, that is to say with an authentication of the user. The token information generated is output to the mobile device, for example via a long-range data communication connection, such as a cellular mobile radio data connection, between the backend system and the mobile device. The token information is stored as data in an electronic memory of the mobile device under the control of the app implemented on the mobile device in such a way that the token information can be read from the memory by the app on the occasion of a subsequent authentication of the user.

In the exemplary embodiment of the method according to the invention, the method may comprise receiving token information assigned to a previous successful authentication of the user from the mobile device, checking the received token information for validity, and relaxing or cancelling a limitation, for the user specified by the valid token information, of a maximum number of processes for authenticating the user that are performable with a negative authentication result. The token information stored on the mobile device, which, as explained above, has been generated only under the necessary condition of a previous successful authentication of the user, is received for example by the backend system via a long-range data communication between the mobile device and the backend system, for example a cellular mobile radio data connection. The received token information is subsequently checked for its validity for example by the backend system on the basis of the pieces of access authorization information stored and managed in the backend system, said access authorization information having been extended by the security data mentioned above upon the generation of the token information. If the check reveals that the received token information is valid, a limitation of a maximum number of processes for authenticating the user that are performable with a negative authentication result is relaxed or cancelled by the backend system, for example. In the case of valid token information, the backend system permits for example a higher number of failed authentication attempts than without valid token information before the backend system automatically refuses further authentication attempts by the user or realizes time-based blocking of the user. If for example the backend system obtains from the mobile device valid token information which contains the user identifier and therefore identifies the user, the backend system blocks the user only after inputting or provision of, for example, 10 invalid collection codes (as access request information still to be provided by the user) instead of blocking after, for example, 3 invalid collection codes without valid token information being provided. The user convenience for those users who have already been successfully authenticated once and are therefore deemed to be trustworthy to a certain extent is increased significantly as a result.

The transmission of the token information from the mobile device to the backend system is initiated for example by an app implemented on the mobile device (or some other software) depending on operational control of the app by the user. If the app implemented on the mobile device may retrieve the token information of the user stored on the mobile device, all that is demanded of the user by the app is to input a portion of the pieces of access request information that are required without stored token information. By way of example, the user whose token information is stored in the mobile device and has been read out by the app no longer has to input his/her user identifier, such as the post number, for example, but rather only a valid collection code, such as the mTAN, for example, into an input interface of the mobile device in order to be authenticated (and thus authorized) for access to a compartment of the compartment installation. Moreover, the app may be configured such that it offers additional compartment-installation-related information services to the user whose token information is stored on the mobile device in a retrievable manner for the app. By way of example, the app is configured such that through operational control of the app without the inputting of any access request information by the user himself/herself (in particular assuming that at this point in time the user is not seeking access to a compartment of the compartment installation) the user may request an overview of his/her shipments with assigned compartment installations from the backend system if the token information assigned to the user is stored on the mobile device and is readable for the app. Overall, the provision of the token information makes it possible to increase convenience and security for the user, provided that the user has previously already been authenticated once by the backend system.

As already mentioned, the present application furthermore discloses:
a computer program, comprising program instructions that cause a processor to perform and/or control the exemplary embodiment of the method according to the invention when the computer program runs on the processor. In this specification, a processor should be understood to mean, inter alia, control units, microprocessors, microcontrol units such as microcontrollers, digital signal processors (DSPs), application-specific integrated circuits (ASICs) or field programmable gate arrays (FPGAs). In this case, either all the steps of the method may be controlled, or all the steps of the method may be performed, or one or more steps may be controlled and one or more steps may be performed. By way of example, the computer program may be distributable via a network such as the internet, a telephone or mobile radio network and/or a local area network. The computer program may at least in part be software and/or firmware of a processor. Equally, it may at least in part be implemented as hardware. By way of example, the computer program may be stored on a computer-readable storage medium, e.g. a magnetic, electrical, optical and/or other kind of storage medium. By way of example, the storage medium may be part of the processor, for example a (nonvolatile or volatile) program memory of the processor or a part thereof. The storage medium may be a substantive or physical storage medium, for example. At least one processor of this type in each case is integrated in the backend system, in each compartment installation and in each mobile device.
an apparatus or a system comprising at least two apparatuses, wherein the apparatus or the system is configured for performing and/or controlling the exemplary embodiment of the method according to the invention, or comprising respective means for performing and/or controlling the steps of the exemplary embodiment of the method according to the invention. In this case, either all the steps of the method may be controlled, or all the steps of the method may be performed, or one or more steps may be controlled and one or more steps may be performed. One or more of the means may also be implemented and/or controlled by the same unit. By way of example, one or more of the means may be formed by one or more processors.
an apparatus comprising at least one processor and at least one memory that includes program code, wherein the memory and the program code are configured to cause an apparatus with the at least one processor to implement and/or to control at least the exemplary embodiment of the method according to the invention. In this case, either all the steps of the method may be controlled, or all the steps of the method may be performed or one or more steps may be controlled and one or more steps may be performed.

Further advantageous exemplary configurations of the invention may be gathered from the following detailed description of some exemplary embodiments of the present invention, in particular in conjunction with the figures. However, the figures accompanying the application are intended to be used only for the purpose of elucidation, but not for determining the scope of protection of the invention. The accompanying drawings are not necessarily true to scale and are intended merely to reflect the general concept of the invention by way of example. In particular, features included in the figures are in no way intended to be regarded as a necessary part of the present invention.

In the figures:

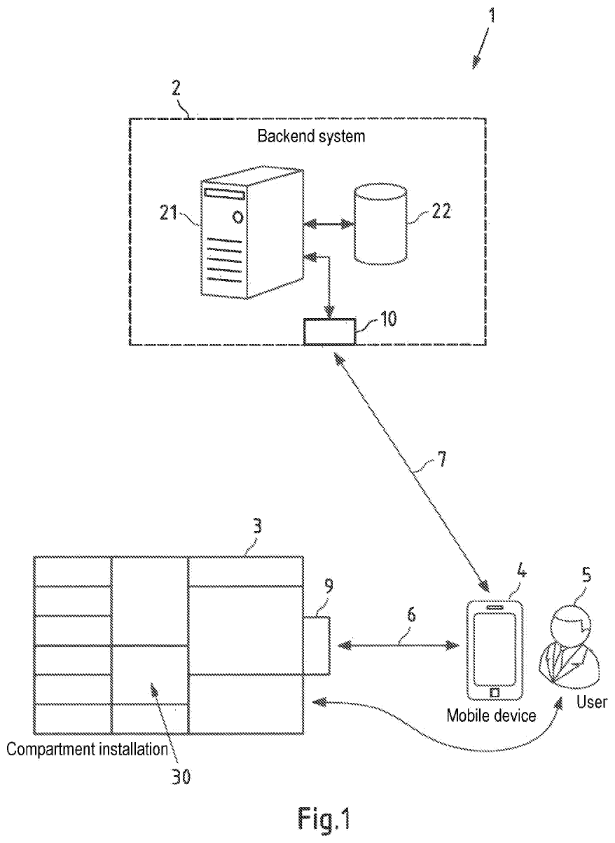

FIG. 1 shows a schematic illustration of an exemplary embodiment of a system according to the present invention;

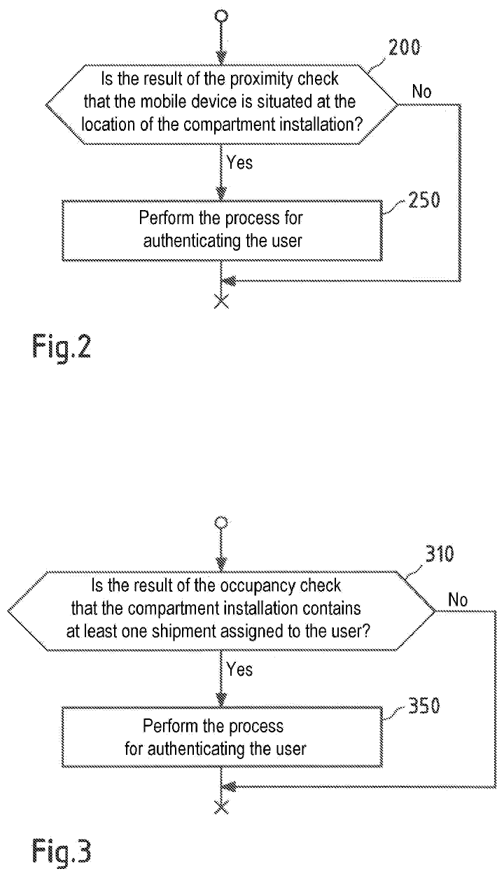

FIG. 2 shows a flow diagram of an exemplary embodiment of a method according to the present invention;

FIG. 3 shows a flow diagram of an exemplary embodiment of a method according to the present invention;

FIG. 4 shows a flow diagram of an exemplary embodiment of a method according to the present invention;

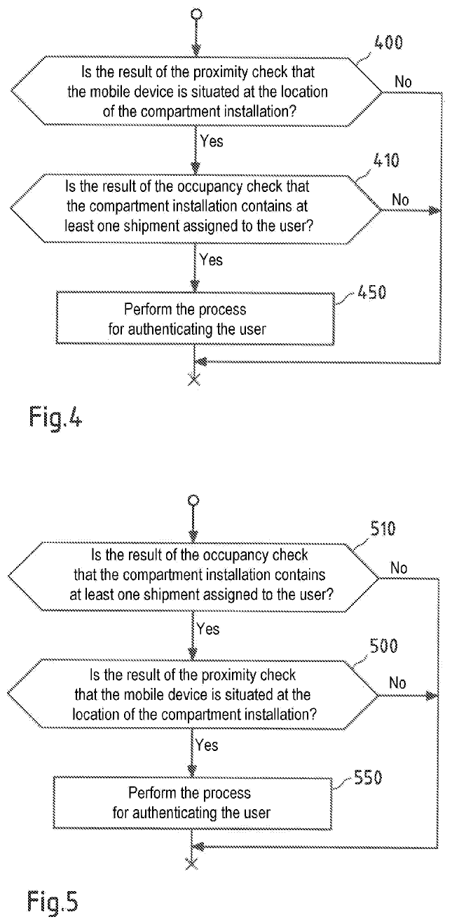

FIG. 5 shows a flow diagram of an exemplary embodiment of a method according to the present invention;

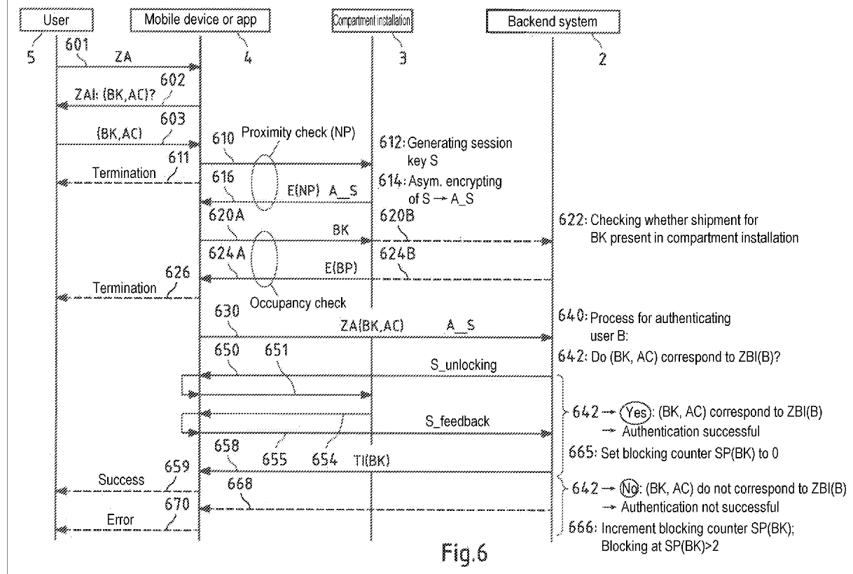

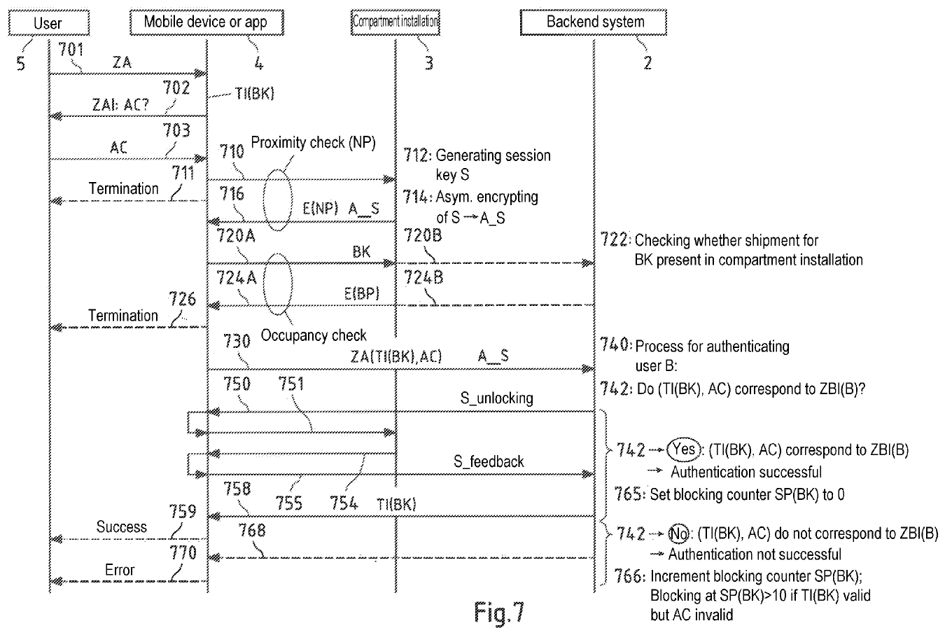

FIG. 6 shows a flow diagram of an exemplary embodiment of a method according to the present invention; and

FIG. 7 shows a flow diagram of an exemplary embodiment of a method according to the present invention.

### DETAILED DESCRIPTION OF SOME EXEMPLARY EMBODIMENTS OF THE INVENTION

FIG. 1 schematically shows a system 1 in accordance with an exemplary embodiment of the present invention.

The system 1 comprises a compartment installation 3 having a plurality of compartments, one compartment of which is provided with reference sign 30 in FIG. 1. Each of the compartments 30 of the compartment installation 3 is provided for receiving a shipment for an individual user. A plurality of compartments may also be assigned to an individual user. Each compartment is locked or closed in the basic state and may be electrically unlocked or opened in an instruction-controlled manner and individually by, for example, a lock control unit provided in the compartment installation 3. One example of such a compartment installation is a compartment installation in accordance with the applicant's known package station concept.

The compartment installation 3 is equipped with one or more communication interface(s) 9 comprising for example an interface for wireless communication with the mobile device 4, for example by means of optical transmission and/or by means of communication based on electrical, magnetic or electromagnetic signals or fields, in particular close-range communication e.g. based on Bluetooth, WLAN, ZigBee, NFC and/or RFID. The compartment installation 3 is not configured for direct communication with the backend system 2, for example, that is to say does not have for example a communication interface that enables access to the internet or to some other network to which the backend system 2 is connected. The compartment installation is not configured for long-range communication, in particular, that is to say does not have in particular an interface to a cellular mobile radio system, a DSL interface or a local area network (LAN) interface.

The current occupancy of the compartments 30 of the compartment installation 3 with the user/compartment assignment is managed centrally by a backend system 2, for example. Alternatively or optionally, the current compartment occupancy with the user/compartment assignment may be stored in the compartment installation 3. The backend system 2 provides central management in respect of which user should be granted access to which compartment 30 of the compartment installation 3, said compartment being locked in the basic state. Users may be understood to mean for example persons who use the compartment installation for receiving and/or sending shipments (e.g. parcels, letters, meals, food, etc.), and deliverers who deliver such shipments into the compartment installation or collect them from the compartment installation. A user may be a human being or a machine, e.g. a vehicle, a robot or a drone, to name just a few examples.

For the user 5 to identify himself/herself vis-à-vis the backend system 2 as a user who has access authorization for a compartment 30, said user, by using a mobile device 4 (which may be for example a mobile phone, in particular a smartphone, or a handheld scanner of a deliverer), must provide pieces of access request information which are to be checked for their validity and which are transmitted to the backend system 2. On the mobile device 4, for example a smartphone, an app, that is to say a complex program, is implemented, for example, which the user installed and started on the mobile device 4 at an earlier point in time, for example upon his/her registration to use the system 1. The mobile device 4 is configured to establish a close-range data communication connection 6, for example Bluetooth, ZigBee, NFC, RFID or WLAN, to the compartment installation 3 or the communication interface 9 thereof and to establish a long-range data communication connection 7, for example via a data communication connection of a cellular mobile radio system, to the backend system 2 or the communication interface 10 thereof, as illustrated by respective arrows in FIG. 1. By way of example, the communication between the mobile device 4 and the backend system 2 is based on the Internet Protocol (IP), wherein the backend system 2 is reachable via the internet, and the mobile device 4 accesses the internet via a wireless radio connection (e.g. a cellular mobile radio connection). The communication between the mobile device 4 and the backend system 2 may be effected in partly or fully encrypted fashion. An app or a program that controls communication with the compartment installation 3, the user 5 and also with the backend system 2 may be installed on the mobile device 4. As a result, the user 5 may use a commercially available smartphone as mobile device 4, for example, on which such an app then merely has to be installed and activated—for example by means of registration in the backend system 2.

The backend system 2 is formed by at least one server apparatus (having at least one processor) 21 and at least one storage apparatus 22, which are coupled to one another for data exchange. Pieces of access authorization information which are assigned to registered users of the system 1 and which are at least in part static or variable over time are stored in the storage apparatus 22. By way of example, a user identifier is static, while a collection code (e.g. an mTAN) is allocated anew for each shipment. The server apparatus 21 performs a process for authenticating the user 5 by comparing the pieces of access request information provided by the user 5 with pieces of access authorization information stored for this user 5 in the storage apparatus 22. Under the necessary condition of correspondence between the pieces of access request information provided and the pieces of access authorization information stored for the user 5 seeking access, the user 5 is authenticated by the backend system 2 and authorized for access to one or more compartments 30 of the compartment installation 3. Otherwise, the backend system 2 denies the user 5 access to compartment(s). The authorization is effected by the backend system 2 instructing the compartment installation 3 to electrically unlock or open the compartment or compartments 30 assigned (in particular temporarily) to the user 5. In the embodiment illustrated in FIG. 1, the instruction from the backend system 2 to the compartment installation 3 is transmitted firstly via the long-range data communication connection 7 to the mobile device 4 and then from the mobile device 4 to the compartment installation 3 via the close-range data communication connection 6. In accordance with the embodiment illustrated in FIG. 1, there is no direct data communication connection between the backend system 2 and the compartment installation 3, rather they may communicate with one another only by way of data relaying via the mobile device 4.

FIG. 2 to FIG. 5 are in each case flow diagrams for illustrating exemplary embodiments of the method according to the present invention.

In the exemplary method illustrated in FIG. 2, firstly a step 200 involves checking whether the result of the proximity check is that the mobile device of the user is situated at the location of the compartment installation. If this is not the case, then the method is ended. Otherwise, if the result of the proximity check is positive, that is to say that the mobile device is situated at the location of the compartment installation, step 200 is followed by step 250, in which the process for authenticating the user is performed.

In the exemplary method illustrated in FIG. 3, in comparison with the method illustrated in FIG. 2, the result of the occupancy check replaces the result of the proximity check. Step 310 involves checking whether the result of the occupancy check is that the compartment installation contains at least one shipment assigned to the user. If the compartment installation does not contain a shipment assigned to the user, the method is ended. Otherwise, if the result of the occupancy check is positive, that is to say that the compartment installation contains at least one shipment assigned to the user, step 310 is followed by step 350, in which the process for authenticating the user is performed.

In the exemplary methods illustrated in FIG. 4 and FIG. 5, the result of the proximity check in step 400 and 500, respectively, and the result of the occupancy check in step 410 and 510, respectively, are evaluated in a cascaded manner. If the result of the check taken into account first, that is to say the proximity check in step 400 in FIG. 4 and respectively the occupancy check in step 510 in FIG. 5, is negative, then the method is ended without taking account of the result of the second check, that is to say the occupancy check in step 410 in FIG. 4 and respectively the proximity check in step 500 in FIG. 5. It is only if the result of the proximity check and the result of the occupancy check are both positive that the method is not terminated, and the process for authenticating the user is performed in step 450 and 550, respectively.

FIG. 6 is a flow diagram of an exemplary embodiment of a method according to the present invention with a detailed illustration of individual steps and of the data exchange respectively associated therewith between the mobile device, the compartment installation and the backend system.

In step 601, the user 5 operates the app implemented on the mobile device 4 to initiate an access request ZA for the compartment installation 3. Afterward, in step 602, the mobile device 4 or the app asks the user 5 to input pieces of access request information ZAI, specifically in the form of a user identifier BK and a collection code AC, which the user 5 inputs into the mobile device 4 or provides for the latter in the subsequent step 603.

After the pieces of access request information have been provided by the user, the proximity check NP follows, beginning with step 610. Specifically, in step 610 the mobile device 4 directs a request to the compartment installation 3 to establish a close-range data communication connection, such as Bluetooth, ZigBee, NFC, RFID or WLAN, for example, as illustrated by the connection line provided with reference sign 6 in FIG. 1. Alternatively, the request to establish the close-range data communication connection may also originate from the compartment installation 3. If the requested close-range data communication connection cannot be established (for example because the distance between the mobile device 4 and the compartment installation 3 is too great), the mobile device 4 terminates the method sequence and notifies the user 5 of the termination of his/her access request in step 611.

Otherwise, that is to say in the case where the close-range data communication connection between the mobile device 4 and the compartment installation 3 is established or arises successfully, the compartment installation 3 generates a random temporary session key Sin step 612. Afterward, in step 614, the temporary session key S is subjected to asymmetric encryption, for example using RSA with a 2048-bit key, by the compartment installation. The public key required for this purpose has been stored in the compartment installation 3 for this purpose, for example during the manufacture or start-up thereof, or during installation of the firmware or during the last firmware update. In step 616, the mobile device 4 ascertains successful establishment of the close-range data communication connection as the result of the proximity check E(NP). In addition, in step 616, the encrypted session key A_S is transmitted from the compartment installation to the mobile device 4 via the close-range data communication connection established. In another embodiment, the encrypted session key A_S is transmitted from the compartment installation 3 to the mobile device 4 for example only after a positive occupancy check separately, that is to say not in association with the proximity check.

Since the proximity check has revealed that the mobile device 4 is situated at the location of the compartment installation 3, since the close-range data communication connection between the compartment installation 3 and the mobile device 4 was able to be established, the mobile device 4 or the app next initiates the determination of the result of the occupancy check BP by means of transmitting the user identifier BK provided as access request information by the user 5 (or the user identifier extracted from the token information) to either the compartment installation 3 (wherein in this case, as already explained, even the interface used for the proximity check is used for a close-range data communication connection, or some other interface is used for a close-range data communication connection) or the backend system 2. If the current occupancy of the compartments 30 of the compartment installation 3 with the user/compartment assignment is also stored in the compartment installation 3 with which the mobile device 4 has already established the close-range data communication connection, in step 620A the mobile device 4 transmits an occupancy check enquiry together with the user identifier BK to the compartment installation 3. For an alternative embodiment in which the current occupancy of the compartments 30 of the compartment installation 3 with the user/compartment assignment is managed and stored exclusively centrally in the backend system 2, in step 620B the mobile device 4 establishes a long-range data communication connection, for example via a cellular mobile radio system, as illustrated by the connection line provided with reference sign 7 in FIG. 1, to the backend system 2 and transmits an occupancy check enquiry together with the user identifier BK to the backend system 2 via the long-range data communication connection established. This transmission may advantageously be encrypted, for example on the basis of cryptographic keys which were agreed between the mobile device 4 or the app and the backend system 2, for example during the installation of the app. Afterward, in step 622, the recipient of the occupancy check enquiry, that is to say either the compartment installation 3 or the backend system 2, checks on the basis of the received user identifier BK whether at least one shipment for the user 5 specified thereby is present in the compartment installation 3. The result of the occupancy check E(BP) is transmitted from the compartment installation 3 or the backend system 2 to the mobile device 4 in step 624A or 624B, respectively. If the result of the occupancy check E(BP) indicates that the compartment installation does not contain a shipment assigned to the user 5, the mobile device 4 terminates the method sequence and notifies the user 5 of the termination of his/her access request ZA in step 626.

By contrast, if the result of the occupancy check E(BP) indicates that the compartment installation contains at least one shipment assigned to the user 5, the process for authenticating the user is initiated in accordance with the method presented. For this purpose, in step 630, the mobile device 4 transmits an access request ZA(BK, AC) specifying the user identifier and the collection code together with the encrypted session key A_S to the backend system 2 via the long-range data communication connection already established in step 620B or now to be established in step 630. The backend system 2 subsequently performs the process for authenticating the user beginning with step 640. For this purpose, step 642 involves checking whether the pieces of access request information BK and AC received from the mobile device 4 correspond to the pieces of access authorization information ZBI(B) stored for the user B in the backend system 2. Alternatively, the collection code AC may also already have been transmitted to the backend system 2 in step 620B (in encrypted fashion, for example, as mentioned), in which case, however, the pieces of access request information BK and AC are not yet evaluated, rather this takes place only after a successful occupancy check E(BP).

If, in the course of performing the process for authenticating the user, the backend system 2 ascertains that the pieces of access request information BK and AC do not correspond to the pieces of access authorization information ZBI(B) (see FIG. 6: 642->no), then the user is not authenticated by the backend system 2, rather the backend system 2 notifies the mobile device 4 in step 668 that the user B has not been authenticated, whereupon the mobile device 4 outputs an error message to the user 5 in step 670. The content of said error message depends on a current value of a user-identifier-specific blocking counter SP(BK), which, each time the process for authenticating the user is performed without resultant successful authentication of the user specified by the user identifier BK, is incremented by one in step 666 and, upon successful authentication of the user 5, is set to zero again, see step 665. If the current value of the blocking counter SP(BK) exceeds a value of 2, the backend system 2 blocks the user identifier BK for further authentication attempts, for example until unblocking by the operator of the backend system, and the mobile device 4 notifies the user 5 of this blocking in step 670.

On the other hand, if, in the course of performing the process for authenticating the user, the backend system 2 ascertains that the pieces of access request information BK and AC correspond to the pieces of access authorization information ZBI(B) (see FIG. 6: 642->yes), then the user is authenticated by the backend system 2. In order to establish secure data exchange with symmetric end-to-end encryption with the session key S (for example using AES with a 256-bit key) between the backend system 2 and the compartment installation 3 during the current session or the current authentication, the backend system 2 firstly decrypts the asymmetrically encrypted session key A_S received from the mobile device 4 with the aid of the private key of the backend system 2 in order to obtain the session key S. Afterward, in steps 650 and 651, the backend system 2 transmits a command S_unlocking encrypted with the session key S and/or signed with said session key to the compartment installation 3 for the purpose of unlocking one compartment or a plurality of compartments 30 assigned to the currently authenticated user B and specifically identified for example in the command S_unlocking (for example on the basis of one or more compartment identifiers). Firstly in step 650, the encrypted and/or signed command S_unlocking is transmitted from the backend system 2 to the mobile device 4 via the long-range data communication connection and then, in step 651, the mobile device 4 transmits the encrypted and/or signed command S_unlocking to the compartment installation 3. For embodiments in which there is a direct data communication connection between the backend system 2 and the compartment installation 3, the encrypted and signed command S_unlocking can also be transmitted directly via this data communication connection without relaying through the mobile device 4. Once the compartment installation 3 has obtained the encrypted and/or signed command S_unlocking, the compartment installation 3 decrypts it with the session key S to form the command unlocking and/or checks the authenticity/integrity of the command S_unlocking and (for example only in the case of a check of the authenticity and integrity with a positive result) unlocks the specified compartment(s), such that the user 5 obtains access to the compartment or compartments assigned to said user. Afterward, the compartment installation 3 generates feedback for the backend system 2, encrypts and/or signs said feedback with the session key S to form S_feedback and transmits the encrypted and/or signed feedback from the compartment installation 3 to the backend system 2 via the mobile device 4 in steps 654 and 655. The backend system 2 receives the message S_feedback, decrypts it with the session key S and/or checks the authenticity/integrity of the command S_feedback, and updates the stored current occupancy of the compartments 30 of the compartment installation 3 with the user/compartment assignment taking account of the current change in compartment occupancy.

To conclude the process for authenticating the user, upon the successful authentication of the user 5, the backend system may optionally generate token information TI(BK), which contains the user identifier BK of the user and security data coupled to the mobile device 4 storing the token information, to the time of installation and/or the version of the app implemented on the mobile device 4, and/or to the time of generation of the token information. The security data included in the token information TI(BK) generated are additionally stored in a user-identifier-specific manner in the backend system 2 in order that token information communicated by a mobile device during a later authentication may be checked for its validity (and also its integrity, for example). In step 658, the token information TI(BK) generated is transmitted from the backend system 2 to the mobile device 4 and stored on the mobile device 4 in a retrievable fashion for the app.

To conclude the successful authentication, in step 659, the mobile device 4 explicitly informs the user of the successful authentication.

FIG. 7 is a flow diagram of an exemplary embodiment of a method according to the present invention with a detailed illustration of individual steps, which substantially correspond to the steps illustrated in FIG. 6, wherein in the transition from FIG. 6 to FIG. 7, for identical or mutually corresponding steps, the leading digit of the step numbering was changed from 6 to 7. The exemplary embodiment of the method illustrated in FIG. 7 will be explained below principally on the basis of the differences with respect to the embodiment illustrated by way of example in FIG. 6.

In contrast to the exemplary embodiment of the method illustrated in FIG. 6, in the exemplary embodiment of the method for authenticating the user as illustrated in FIG. 7, token information TK(BI) stored in the mobile device and containing the user identifier BK is read out. In contrast to steps 602, 603, the mobile device 4 only asks the user 5 to input the collection code AC in step 702 and accepts the collection code AC that has been input in step 703. In the method in FIG. 7, the mobile device 4 reads out the user identifier BK from the token information TI(BK) stored on the mobile device 4.

Unlike in step 630 of the method illustrated in FIG. 6, in step 730 of the method illustrated in FIG. 7, the token information TI(BK) read out from the mobile device 4 and the collection code AC are transmitted as pieces of access request information to the backend system 2. In the process for authenticating the user in accordance with the method in FIG. 7, therefore, step 742 involves checking whether the received token information TI(BK) and the collection code AC correspond to the pieces of access authorization information ZIB(B). In contrast to the method illustrated in FIG. 6, the user-specific pieces of access authorization information ZIB(B) also represent or contain the token information TI(BK) whose data were included in the pieces of access authorization information ZIB (B) during the last performed authentication of the user with the user identifier. In the case where the backend system 2 does not ascertain correspondence in step 742, the user is not authenticated, as in step 642 in FIG. 6. Unlike in step 666 in FIG. 6, however, in step 766 of the embodiment illustrated in FIG. 7, the blocking of the user with the user identifier BK is performed less restrictively. If it was ascertained in step 742 that the token information TI(BK) and the collection code AC are invalid, then as in step 666, in step 766 as well the user with the user identifier BK is blocked if the blocker counter SP(BK) is greater than 2, for example. However, if it was ascertained in step 742 that the token information TI(BK) is valid and only the collection code AC is invalid, then the user with the user identifier BK is blocked only when the blocking counter SP(BK) has exceeded a significantly higher value than the comparison basis mentioned previously with regard to step 666, for example only when the blocking counter SP(BK) is greater than 10. This reflects the fact that a user 5 who has already been successfully authenticated once is shown greater trust than an unknown user.

In the exemplary methods in FIGS. 6 and 7, the proximity check takes place before the occupancy check. This order may also be interchanged in alternative embodiments of the method according to the invention. An occupancy check with a negative result then leads to the termination of the respective method, such that a proximity check is no longer performed, while an occupancy check with a positive result has the consequence that the proximity check is performed. Depending on the outcome of the proximity check, the rest of the respective method is then performed (positive result of the proximity check) or is not performed (negative result of the proximity check).

Furthermore, an additional check may optionally be provided in the exemplary methods in FIGS. 6 and 7. This involves checking whether or not an authentication enquiry that is intended to initiate the process for authenticating the user is classified as suspicious on account of a counter. The authentication enquiry may be for example the enquiry directed to the backend system 2 in step 620B and 720B, respectively, or the enquiry directed to the backend system 2 in step 630 and 730, respectively. The counter is controlled in a user-identifier-specific manner by the backend system 2, for example, and detects, for example, how often within a predefined time interval, or time interval adapted dynamically according to a predefined rule, the authentication enquiry was made to the backend system 2. If the counter exceeds a predefined threshold value, or threshold value adapted dynamically according to a predefined rule, a decision is taken, for example, that the authentication enquiry should be classified as suspicious since it has taken place too frequently within the time interval. This has the consequence that the process for authenticating the user is not performed, that is to say that the method in FIGS. 6 and 7 then terminates, and the user 5 is notified accordingly by the mobile device 4. This additional check is preferably performed before the occupancy check, such that if the result of the check is negative, the occupancy check (and also the downstream steps of the method in FIGS. 6 and 7) need no longer be performed.

The components of the system 1 that are presented in this application should also be understood to be disclosed in each case in their own right. This applies specifically to the backend system 2, the compartment installation 3 and the mobile device 4 and also the methods performed by them:

In accordance with one aspect, the present invention comprises a backend system (in particular as explained by way of example above), for example having at least one server apparatus and at least one storage apparatus coupled thereto for data exchange, which backend system is configured in particular for one or more of the following steps:
managing and granting (optionally also blocking) in particular compartment-specific and/or user-specific access to compartments of one or more compartment installations described above, said compartments being individually unlockable by means of an instruction by the backend system,
storing and managing user-specific pieces of access authorization information,
receiving pieces of access request information provided by a user,
data exchange with the managed compartment installation(s),
data exchange with at least one mobile device of a user,
performing a process for authenticating a user on the basis of the pieces of access request information provided by the user and the pieces of access authorization information stored in the backend system, wherein a necessary condition for performing the process for authenticating the user is that a proximity check has revealed that a mobile device of the user is situated at the location of the compartment installation, and/or that an occupancy check has revealed that the compartment installation contains at least one shipment assigned to the user.

Developments of a backend system in accordance with this aspect are configured to perform method steps from the group of claims 2 to 10 and 12 to 15.

In accordance with a further aspect, the present invention encompasses a compartment installation (in particular as described above) having a plurality of compartments that are individually unlockable in particular by a lock control apparatus of the compartment installation, wherein the compartment installation is configured in particular to perform one or more of the following steps:
establishing a close-range data communication connection to a mobile device of a user of the compartment installation,
generating a temporary session key,
encrypting the temporary session key generated, preferably by means of asymmetric encryption,
outputting the encrypted session key for use by a backend system that manages the compartment installation and is configured as described above,
performing data communication with the backend system with end-to-end encryption and/or signing of messages using the temporary session key for the purpose of controlling the compartment installation by means of the backend system.

In accordance with a further aspect, the present invention encompasses a mobile device (in particular as described above) configured to perform one or more of the following steps:
receiving pieces of access request information from a user,
establishing data communication with a compartment installation via a close-range data communication connection between the mobile device and the compartment installation,
establishing data communication with a backend system via a long-range data communication connection between the mobile device and the backend system,
transmitting the pieces of access request information received to the backend system,
establishing data communication between the compartment installation and the backend system by means of data relaying through the mobile device for the purpose of controlling the compartment installation by means of the backend system.

The following exemplary embodiments of the invention shall also be understood to be disclosed (therein, the reference signs given in brackets are exemplary and shall not be considered limiting in any way):

### Embodiment 1

Method, comprising:
performing a process for authenticating a user (250, 350, 450, 550) of a compartment installation (3) vis-à-vis a backend system (2) managing the compartment installation, wherein a necessary condition for performing the process for authenticating the user (250, 350, 450, 550) is that a proximity check (200, 400, 500) has revealed that a mobile device (4) of the user (5) is situated at the location of the compartment installation (3), and/or that an occupancy check (310, 410, 510) has revealed that the compartment installation (3) contains at least one shipment assigned to the user (5).

### Embodiment 2

Method according to Embodiment 1, wherein under the condition that a close-range data communication connection (6, 610, 616, 710, 716) between the compartment installation (3) and the mobile device (4) is establishable or has been established, the proximity check (200, 400, 500) reveals that the mobile device is situated at the location of the compartment installation.

### Embodiment 3

Method according to Embodiment 1 or 2, wherein under the condition that the backend system (2) may decrypt a message (A_S) encrypted by the compartment installation (3) and/or that the backend system (2) has ascertained the integrity and authenticity of a message provided with a signature by the compartment installation, the proximity check (200, 400, 500) reveals that the mobile device is situated at the location of the compartment installation.

### Embodiment 4

Method according to any of Embodiments 1 to 3, wherein the result of the proximity check (200, 400, 500) is determined not solely by means of a position determination performable independently by the mobile device (4), preferably without independent position determination by the mobile device (4).

### Embodiment 5

Method according to any of Embodiments 1 to 4, wherein the result of the proximity check (400, 500) and the result of the occupancy check (410, 510) are taken into account in a cascaded manner as the necessary condition for performing the process for authenticating the user (250, 350, 450, 550).

### Embodiment 6

Method according to any of Embodiments 1 to 5, wherein the result of the occupancy check (410) is only determined and/or taken into account as the necessary condition for performing the process for authenticating the user (250, 350, 450, 550) if the proximity check (400) has revealed or reveals that the mobile device is situated at the location of the compartment installation.

### Embodiment 7

Method according to any of Embodiments 1 to 6, wherein the result of the occupancy check (310, 410, 510) is defined (620B) by the backend system on the basis of one or more pieces of access request information (BK) provided by the mobile device (4).

### Embodiment 8

Method according to any of Embodiments 1 to 7, wherein a data communication connection (6, 7) between the backend system (2) and the compartment installation (3) is operated, preferably only, by means of relaying through the mobile device (4).

### Embodiment 9

Method according to Embodiment 8, wherein the data communication connection (6, 7) between the backend system (2) and the compartment installation (3) is established and operated only under the necessary condition that the occupancy check (200, 400, 500) has revealed that the mobile device is situated at the location of the compartment installation, and/or that the occupancy check (310, 410, 510) has revealed that the compartment installation contains at least one shipment assigned to the user.

### Embodiment 10

Method according to Embodiment 8 or 9, wherein the data communication connection (6, 7) between the backend system (2) and the compartment installation (3) is established and operated (650-655, 750-755) only under the necessary condition that the user (5) was successfully authenticated (642, 742).

### Embodiment 11

Method according to any of Embodiments 1 to 10, furthermore comprising:
generating (612, 712) a temporary session key (S);
encrypting (614, 714) the temporary session key (S) generated, preferably by means of asymmetric encryption; and
transmitting (616, 716) the encrypted session key (A_S) to the backend system (2).

### Embodiment 12

Method according to any of Embodiments 1 to 11, furthermore comprising:
receiving (616, 630, 716, 730) an encrypted session key (A_S), preferably encrypted by means of asymmetric encryption, from the compartment installation (3);
decrypting the encrypted session key (A_S); and
end-to-end encrypting, using the decrypted session key (S), of a data communication (S_unlocking, S_feedback) between the backend system (2) and the compartment installation (3), preferably by means of symmetric encryption.

### Embodiment 13

Method according to any of Embodiments 1 to 12, furthermore comprising:
generating—upon successful authentication of a user—token information (TI(BK)) assigned to the user and outputting (658, 758) it to the mobile device (4) for storage for a future process for authenticating the user.

### Embodiment 14

Method according to any of Embodiments 1 to 13, furthermore comprising:
receiving (730) token information (TI(BK)) assigned to a previous successful authentication of the user from the mobile device (4);
checking the received token information for validity (742); and
relaxing or cancelling a limitation, for the user specified by the valid token information, of a maximum number of processes for authenticating the user that are performable with a negative authentication result (766).

### Embodiment 15

Method according to any of Embodiments 1 to 14, wherein an additional necessary condition for performing the process for authenticating the user is that an authentication enquiry that is intended to initiate the process for authenticating the user has not been classified as suspicious on the basis of a counter.

### Embodiment 16

Apparatus (2, 3, 4) or system (1) comprising at least two apparatuses, configured for performing and/or controlling the method according to any of Embodiments 1 to 15 or comprising respective means for performing and/or controlling the steps of the method according to any of Embodiments 1 to 15.

### Embodiment 17

An apparatus comprising at least one processor and at least one memory that includes program code, wherein the memory and the program code are configured to cause an apparatus, in particular an authentication apparatus, with the at least one processor to implement and/or to control at least the method of any of Embodiments 1 to 15. The apparatus comprising the at least one processor and the at least one memory may for instance be or comprise the authentication apparatus, or be different therefrom.

### Embodiment 18

Computer program, comprising program instructions that cause a processor to perform and/or control the method according to any of Embodiments 1 to 15 when the computer program runs on the processor.

The embodiments/exemplary embodiments of the present invention that are described in this specification should also be understood to be disclosed in all combinations with one another. In particular, the description of a feature that an embodiment comprises should also not—unless explicitly explained to the contrary—be understood in the present case to mean that the feature is indispensable or essential for the function of the exemplary embodiment. The sequence of the method steps outlined in this specification in the individual flow diagrams is not mandatory; alternative sequences of the method steps are conceivable. The method steps may be implemented in various ways, and so implementation using software (through program instructions), hardware or a combination of the two is conceivable for implementing the method steps. Terms used in the patent claims such as “comprise”, “have”, “include”, “contain” and the like do not exclude further elements or steps. The wording “at least partly” encompasses both the case “partly” and the case “completely”. The wording “and/or” should be understood to the effect that both the alternative and the combination are intended to be disclosed, that is to say that “A and/or B” means “(A) or (B) or (A and B)”. In the context of this specification, a plurality of units, persons or the like means two or more units, persons or the like. The use of the indefinite article does not exclude a plurality. A single device may perform the functions of a plurality of units or devices mentioned in the patent claims. Reference signs indicated in the patent claims should not be regarded as limitations for the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus comprising at least one processor and at least one memory that includes program code, wherein the memory and the program code are configured to cause an apparatus with the at least one processor to implement and/or to control at least:
performing a process for authenticating a user of a compartment installation vis-à-vis a backend system managing the compartment installation, wherein a necessary condition for performing the process for authenticating the user is that a proximity check has revealed that a mobile device of the user is situated at the location of the compartment installation, and/or that an occupancy check has revealed that the compartment installation contains at least one shipment assigned to the user.

2. The apparatus according to claim 1, wherein under the condition that a close-range data communication connection between the compartment installation and the mobile device is establishable or has been established, the proximity check reveals that the mobile device is situated at the location of the compartment installation.

3. The apparatus according to claim 1, wherein under the condition that the backend system may decrypt a message encrypted by the compartment installation and/or that the backend system has ascertained the integrity and authenticity of a message provided with a signature by the compartment installation, the proximity check reveals that the mobile device is situated at the location of the compartment installation.

4. The apparatus according to claim 1, wherein the result of the proximity check is determined not solely by means of a position determination performable independently by the mobile device, preferably without independent position determination by the mobile device.

5. The apparatus according to claim 1, wherein the result of the proximity check and the result of the occupancy check are taken into account in a cascaded manner as the necessary condition for performing the process for authenticating the user.

6. The apparatus according to claim 1, wherein the result of the occupancy check is only determined and/or taken into account as the necessary condition for performing the process for authenticating the user if the proximity check has revealed or reveals that the mobile device is situated at the location of the compartment installation.

7. The apparatus according to claim 1, wherein the result of the occupancy check is defined by the backend system on the basis of one or more pieces of access request information provided by the mobile device.

8. The apparatus according to claim 1, wherein a data communication connection between the backend system and the compartment installation is operated, preferably only, by means of relaying through the mobile device.

9. The apparatus according to claim 8, wherein the data communication connection between the backend system and the compartment installation is established and operated only under the necessary condition that the occupancy check has revealed that the mobile device is situated at the location of the compartment installation, and/or that the occupancy check has revealed that the compartment installation contains at least one shipment assigned to the user.

10. The apparatus according to claim 8, wherein the data communication connection between the backend system and the compartment installation is established and operated only under the necessary condition that the user was successfully authenticated.

11. The apparatus according to claim 1, wherein the memory and the program code are further configured to cause the apparatus with the at least one processor to implement and/or to control:
generating a temporary session key;
encrypting the temporary session key generated, preferably by means of asymmetric encryption; and
transmitting the encrypted session key to the backend system.

12. The apparatus according to claim 1, wherein the memory and the program code are further configured to cause the apparatus with the at least one processor to implement and/or to control:
receiving an encrypted session key, preferably encrypted by means of asymmetric encryption, from the compartment installation;
decrypting the encrypted session key; and
end-to-end encrypting, using the decrypted session key, of a data communication between the backend system and the compartment installation, preferably by means of symmetric encryption.

13. The apparatus according to claim 1, wherein the memory and the program code are further configured to cause the apparatus with the at least one processor to implement and/or to control:
generating—upon successful authentication of a user—token information assigned to the user and outputting it to the mobile device for storage for a future process for authenticating the user.

14. The apparatus according to claim 1, wherein the memory and the program code are further configured to cause the apparatus with the at least one processor to implement and/or to control:
receiving token information assigned to a previous successful authentication of the user from the mobile device;
checking the received token information for validity; and
relaxing or cancelling a limitation, for the user specified by the valid token information, of a maximum number of processes for authenticating the user that are performable with a negative authentication result.

15. The apparatus according to claim 1, wherein an additional necessary condition for performing the process for authenticating the user is that an authentication enquiry that is intended to initiate the process for authenticating the user has not been classified as suspicious on the basis of a counter.

16. The apparatus according to claim 1, wherein the apparatus comprising the at least one processor and the at least one memory is an apparatus of the backend system.

17. A method, comprising:
performing a process for authenticating a user of a compartment installation vis-à-vis a backend system managing the compartment installation, wherein a necessary condition for performing the process for authenticating the user is that a proximity check has revealed that a mobile device of the user is situated at the location of the compartment installation, and/or that an occupancy check has revealed that the compartment installation contains at least one shipment assigned to the user.

18. The method according to claim 17, wherein under the condition that a close-range data communication connection between the compartment installation and the mobile device is establishable or has been established, the proximity check reveals that the mobile device is situated at the location of the compartment installation.

19. The method according to claim 17, wherein under the condition that the backend system may decrypt a message encrypted by the compartment installation and/or that the backend system has ascertained the integrity and authenticity of a message provided with a signature by the compartment installation, the proximity check reveals that the mobile device is situated at the location of the compartment installation.

20. A computer program, comprising program instructions that cause a processor to perform and/or control the following when the computer program runs on the processor:
performing a process for authenticating a user of a compartment installation vis-à-vis a backend system managing the compartment installation, wherein a necessary condition for performing the process for authenticating the user is that a proximity check has revealed that a mobile device of the user is situated at the location of the compartment installation, and/or that an occupancy check has revealed that the compartment installation contains at least one shipment assigned to the user.
